(19) United States
(12) Patent Application Publication
(10) Pub. No.: US 2022/0297600 A1
(43) Pub. Date: Sep. 22, 2022

(54) VEHICLE PERIPHERY WARNING DEVICE AND VEHICLE PERIPHERY WARNING METHOD

(71) Applicant: Panasonic Intellectual Property Management Co., Ltd., Osaka (JP)

(72) Inventors: Shingo KAWAHARA, KANAGAWA KEN (JP); Atsushi SEKI, KANAGAWA KEN (JP)

(73) Assignee: Panasonic Intellectual Property Management Co., Ltd., Osaka (JP)

(21) Appl. No.: 17/688,311

(22) Filed: Mar. 7, 2022

(30) Foreign Application Priority Data
Mar. 16, 2021 (JP) 2021-042705

(51) Int. Cl. B60Q 9/00

(52) U.S. Cl. CPC B60Q 9/008

(57) ABSTRACT

A vehicle periphery warning device includes a detector device and a hardware processor. The detector device detects a second vehicle differing from a first vehicle. The hardware processor functions as a setting unit, an activation controller, and a corrector. The setting unit serves to set a warning area on a downstream side in a traveling direction of the first vehicle in accordance with an angle between the traveling direction of the first vehicle and a traveling direction of the second vehicle. The activation controller serves to, when the second vehicle enters the warning area, activate a warning operation activator device performing a warning operation. The corrector serves to correct the warning area when accuracy of detecting the second vehicle by the detector device is lower than a predetermined degree of accuracy.

### CROSS-REFERENCE TO RELATED APPLICATIONS

This application is based upon and claims the benefit of priority from Japanese Patent Application No. 2021-042705, filed on Mar. 16, 2021, the entire contents of which are incorporated herein by reference.

### FIELD

The present disclosure relates generally to a vehicle periphery warning device and a vehicle periphery warning method.

### BACKGROUND

There is known control for issuing, when a present vehicle in a parked state starts moving backward, a warning about another vehicle which may cross the present vehicle. Examples of such a control include a device that sets a warning area in the periphery of a present vehicle when another approaching vehicle is detected, and issues a warning when the other vehicle enters the warning area (for example, Japanese Patent Publication No. 5435172).

However, in the related art, when accuracy of detecting another vehicle deteriorates, it is difficult to set an appropriate warning area. That is, it is difficult for the related art to appropriately watch out for another vehicle.

There is a demand for appropriately watching out for another vehicle.

### SUMMARY

A vehicle periphery warning device includes a detector device and a hardware processor. The detector device is configured to detect a second vehicle differing from a first vehicle. The hardware processor is connected to a memory and configured to function as a setting unit, an activation controller, and a corrector. The setting unit serves to set a warning area on a downstream side in a traveling direction of the first vehicle in accordance with an angle between the traveling direction of the first vehicle and a traveling direction of the second vehicle. The activation controller serves to, when the second vehicle enters the warning area, activate a warning operation activator device performing a warning operation. The corrector serves to correct the warning area when accuracy of detecting the second vehicle by the detector device is lower than a predetermined degree of accuracy.

### BRIEF DESCRIPTION OF THE DRAWINGS

FIG. 1 is a block diagram of a functional configuration of a vehicle on which a vehicle periphery warning device according to an embodiment of the present disclosure is mounted;

FIG. 2 is an explanatory diagram of an exemplary layout of detectors;

FIG. 3 is a hardware configuration diagram of the vehicle periphery warning device;

FIG. 4 is an explanatory diagram of setting of a warning area;

FIG. 5 is an explanatory diagram of a relation between an angle and a distance;

FIG. 6 is an explanatory diagram of another relation between the angle and the distance;

FIG. 7 is an explanatory diagram of a case where an angle between a traveling direction of a present vehicle and a traveling direction of another vehicle exceeds 90 degrees;

FIG. 8A is an explanatory diagram of a case where a speed of the other vehicle is equal to or lower than a set speed;

FIG. 8B is an explanatory diagram of a case where the other vehicle is detected in an area within a predetermined range from an edge of a detection angle of a detector;

FIG. 9A is an explanatory diagram of an example of correction of the warning area;

FIG. 9B is an explanatory diagram of another example of the correction of the warning area; and

FIG. 10 is a flowchart illustrating an example of information processing.

### DETAILED DESCRIPTION

The following describes an embodiment of a vehicle periphery warning device and a vehicle periphery warning method according to the present disclosure.

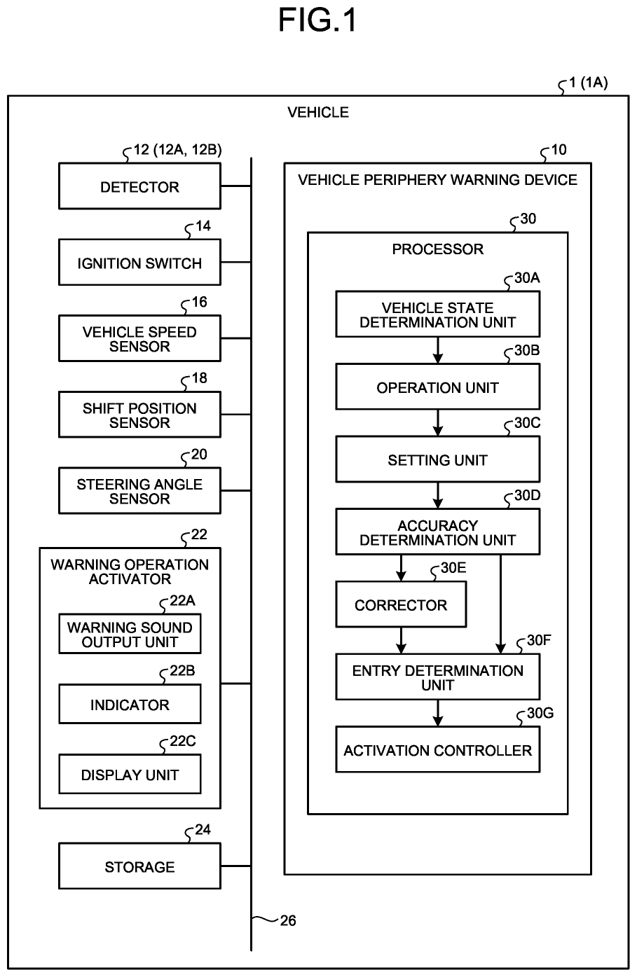

FIG. 1 is a block diagram of a functional configuration of a vehicle 1 on which a vehicle periphery warning device 10 according to the present embodiment is mounted.

In the present embodiment, a configuration in which the vehicle periphery warning device 10 is mounted on the vehicle 1 will be described as an example. In the present embodiment, the vehicle 1 on which the vehicle periphery warning device 10 is mounted may be called a present vehicle 1A (an example of the first vehicle), and a vehicle as a warning target may be called another (or the other) vehicle (an example of the second vehicle).

The vehicle periphery warning device 10 is an information processing device that makes a warning about the other vehicle.

The present vehicle 1A includes the vehicle periphery warning device 10, a detector 12, an ignition switch 14, a vehicle speed sensor 16, a shift position sensor 18, a steering angle sensor 20, a warning operation activator 22, and a storage 24. The vehicle periphery warning device 10, the detector 12, the ignition switch 14, the vehicle speed sensor 16, the shift position sensor 18, the steering angle sensor 20, the warning operation activator 22, and the storage 24 are communicably connected together via a bus 26.

The detector 12 (an example of the detector device) is a sensor for detecting the other vehicle present in the periphery of the present vehicle 1A. The periphery of the present vehicle 1A refers to a detection range of the detector 12.

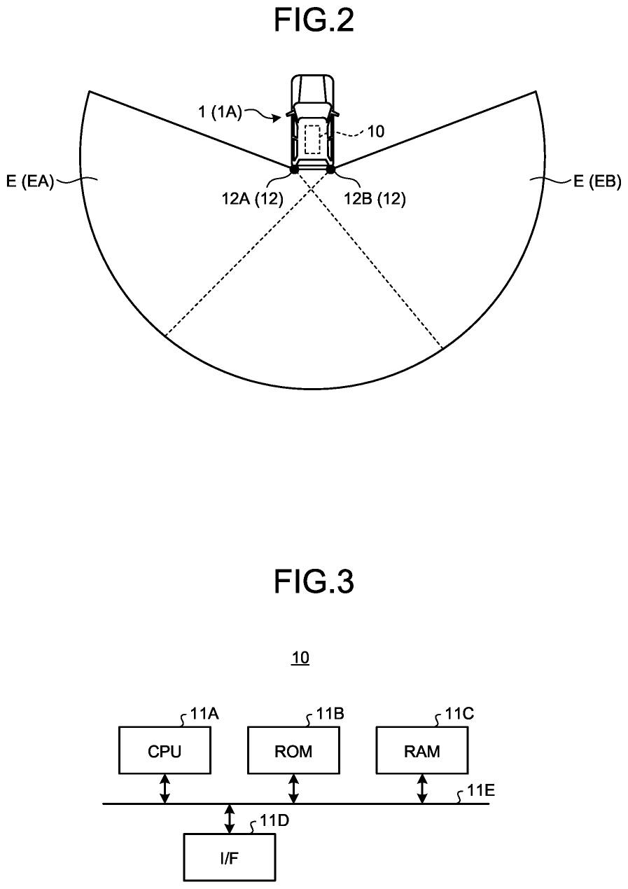

FIG. 2 is an explanatory diagram of an exemplary layout of the detectors 12. In the present embodiment, a configuration, in which the present vehicle 1A is provided with two or more detectors 12, will be described as an example. The present vehicle 1A includes a detector 12A and a detector 12B as the detectors 12. The detector 12A and the detector 12B are provided on one side in the overall length direction orthogonal to the vehicle width direction of the vehicle 1. Specifically, the detector 12A and the detector 12B are provided, for example, at a rear bumper of the present vehicle 1A.

The number and the layout of the detectors 12 provided on the present vehicle 1A are not limited to the above-described configuration. The configuration may be such that a single detector 12 is provided in a rear portion of the present vehicle 1A. Alternatively, the configuration may be such that the detectors 12 are also provided in, for example, a front portion and side portions of the present vehicle 1A. The present vehicle 1A may have a configuration including three or more of the detectors 12. In the present embodiment, a configuration, in which the detector 12A and the detector 12B are provided in the rear portion of the present vehicle 1A, will be described as an example.

That is, in the present embodiment, a configuration will be described as an example in which the detector 12A and the detector 12B are each provided in a position on one side in the overall length direction orthogonal to the vehicle width direction of the present vehicle 1A, where the rear side of the present vehicle 1A can be detected.

The detector 12A and the detector 12B detect the other vehicle in the respective detection ranges E (EA and EB), and output detection information about the other vehicle to the vehicle periphery warning device 10. The detection information includes the position of the other vehicle with respect to the present vehicle 1A, the traveling direction of the other vehicle with respect to the central axis of the present vehicle 1A, and the speed of the other vehicle.

The detector 12 is required to be capable of detecting the other vehicle and outputting the detection information. The detector 12 is, for example, millimeter-wave radar, a laser radar device, or a stereo camera device. In the present embodiment, a configuration in which each of the detectors 12 is a millimeter-wave radar will be described as an example.

The detector 12 being the millimeter-wave radar calculates, by using detection results of objects, the distance between the present vehicle 1A and the other vehicle, the relative speed of the other vehicle, and the azimuth of the other vehicle with respect to the present vehicle 1A by means of a known method. For example, the detector 12 can use a known method such as a frequency modulated continuous wave (FM-CW) method or a digital beam forming (DBF) method.

In more detail, by using received waves with respect to emitted radio waves, the detectors 12 calculate the distances from the present vehicle 1A to the objects, the relative speeds of the objects, and the azimuths of the objects with respect to the present vehicle 1A by means of, for example, the FM-CW method or the DBF method. The detectors 12 further calculate, from the calculated parameters, the positions of the objects, the moving directions of the objects, and the moving speeds of the objects with respect to the present vehicle 1A. Then, the detectors 12 perform screening on the objects, for which the positions, the moving directions, and the moving speeds have been calculated, by using the sizes and the speeds estimated from intensities of the received waves as conditions. By performing such screening, the detectors 12 extract the vehicle from among the detected objects. By performing this extraction processing, the detectors 12 obtain the detection information including the position of the other vehicle with respect to the present vehicle 1A, the traveling direction of the other vehicle with respect to the central axis of the present vehicle 1A, and the speed of the other vehicle.

The central axis of the present vehicle 1A refers to a line that is parallel to a direction matching the overall length direction orthogonal to the vehicle width direction of the present vehicle 1A, and that passes through the center of the present vehicle 1A. In other words, the central axis of the present vehicle 1A refers to a line parallel to the traveling direction of the present vehicle 1A. The detectors 12 can use a known method to determine the central axis of the present vehicle 1A and calculate the traveling direction of the other vehicle with respect to the central axis.

The detectors 12 output, to the vehicle periphery warning device 10, pieces of information about the position of the other vehicle with respect to the present vehicle 1A, the traveling direction of the other vehicle with respect to the central axis of the present vehicle 1A, and the speed of the other vehicle, which are the detection information about the other vehicle.

The description will be continued referring back to FIG. 1. The ignition switch 14 is a switch for instructing the engine start and the start of various electrical systems in the present vehicle 1A. By operating the ignition switch 14, an instruction such as an engine-off instruction, an accessory power-off instruction, an accessory power-on instruction, or an engine-on instruction is input. The ignition switch 14 serves to output the instruction information to the vehicle periphery warning device 10.

The vehicle speed sensor 16 is a sensor that measures the vehicle speed of the present vehicle 1A. The vehicle speed sensor 16 outputs the measurement result of the vehicle speed to the vehicle periphery warning device 10. The shift position sensor 18 is a sensor that detects the position of a shift lever. The shift position sensor 18 detects the position of the shift lever, such as a parking position, a reverse position, a neutral position, or a normal drive position. The shift position sensor 18 outputs the position information of the shift lever to the vehicle periphery warning device 10. The steering angle sensor 20 detects the steering angle of a steering wheel provided in the vehicle 1, and outputs the steering angle as steering angle information to the vehicle periphery warning device 10.

The warning operation activator 22 (an example of the warning operation activator device) is a device that performs a warning operation. The warning operation refers to, for example, an operation to give notification of information for prompting a caution to an occupant of the vehicle 1 and an occupant of another vehicle 2. The notification of the information may be performed by, for example, a sound, light, an image, and/or vibration.

In the present embodiment, the warning operation activator 22 includes a warning sound output unit 22A, an indicator 22B, and a display unit 22C.

The warning sound output unit 22A is an audio output device such as a speaker that outputs a warning sound. The indicator 22B is a light-emitting device that is lit up or blinks. The indicator 22B is provided in, for example, an inner mirror, outer mirrors, and a combination meter of the vehicle 1. The display unit 22C is a display device that displays at least one of a text and an image for prompting the caution.

The storage 24 stores various types of information. The storage 24 is, for example, a semiconductor memory element such as a random-access memory (RAM) or a flash memory, a hard disk, or an optical disc. The storage 24 may be a storage medium. Specifically, the storage medium may be a medium on which computer programs or the various types of information downloaded via a local area network (LAN) and the Internet are stored or temporarily stored. The storage 24 may be constituted by two or more storage media.

The detectors 12, the ignition switch 14, the vehicle speed sensor 16, the shift position sensor 18, the steering angle sensor 20, the warning operation activator 22, and the storage 24 are communicably connected to various engine control units (ECUs) provided in the vehicle 1. In the present embodiment, details of relations between those components and the ECUs are omitted.

The following describes the vehicle periphery warning device 10 in detail.

FIG. 3 is an exemplary hardware configuration diagram of the vehicle periphery warning device 10.

The vehicle periphery warning device 10 has a hardware configuration using a general computer in which, for example, a central processing unit (CPU) 11A, a read-only memory (ROM) 11B, a RAM 11C, and an interface (I/F) 11D are connected to one another by a bus 11E.

The CPU 11A (an example of the hardware processor) is an arithmetic device that controls the vehicle periphery warning device 10 of the present embodiment. The ROM 11B stores, for example, computer programs causing the CPU 11A to execute various types of processing. The RAM 11C stores data required for the various types of processing by the CPU 11A. The IN 11D is an interface for transmitting and receiving data.

A computer program for executing the information processing performed by the vehicle periphery warning device 10 of the present embodiment is provided by being incorporated in advance in, for example, the ROM 11B. The computer program to be executed by the vehicle periphery warning device 10 of the present embodiment may be provided by being recorded as a file installable or executable on the vehicle periphery warning device 10 on a computer readable recording medium such as a compact disc read-only memory (CD-ROM), a flexible disk (FD), a compact disc recordable (CD-R), or a digital versatile disc (DVD).

The description will be continued referring back to FIG. 1.

The vehicle periphery warning device 10 includes a processor 30. The processor 30 executes various types of information processing. For example, the CPU 11A reads the computer program from the ROM 11B into the RAM 11C and executes the read computer program to implement functional units (to be described later) of the processor 30 on the computer. The computer program is, for example, a computer program implemented in an autonomous emergency brake (AEB) application, but is not limited thereto. The autonomous emergency brake application is an example of software that runs on the vehicle periphery warning device 10.

The processor 30 includes a vehicle state determination unit 30A, an operation unit 30B, a setting unit 30C, an accuracy determination unit 30D, a corrector 30E, an entry determination unit 30F, and an activation controller 30G. Some or all of the vehicle state determination unit 30A, the operation unit 30B, the setting unit 30C, the accuracy determination unit 30D, the corrector 30E, the entry determination unit 30F, and the activation controller 30G may be implemented by, for example, causing a processing device such as the CPU 11A to execute a computer program, that is, implemented by software, or may be implemented by hardware such as integrated circuits (ICs), or may be implemented by using software and hardware. At least one of the vehicle state determination unit 30A, the operation unit 30B, the setting unit 30C, the accuracy determination unit 30D, the corrector 30E, the entry determination unit 30F, and the activation controller 30G may be mounted on an external information processing device communicably connected to the vehicle periphery warning device 10 via, for example, a network.

The vehicle state determination unit 30A serves to determine the vehicle state of the present vehicle 1A. In more detail, the vehicle state determination unit 30A determines whether the vehicle state of the present vehicle 1A corresponds to a state satisfying an activation condition of the warning operation activator 22. For example, the vehicle state determination unit 30A determines whether the vehicle state satisfies the activation condition by using information received from the detector 12, the ignition switch 14, the vehicle speed sensor 16, the shift position sensor 18, and the steering angle sensor 20.

The activation condition may be set in advance. In the present embodiment, a configuration will be described as an example in which the activation condition is a transition from a parked state of the present vehicle 1A to a vehicle state where the present vehicle 1A starts moving backward. Therefore, in the present embodiment, the vehicle state determination unit 30A determines whether the state satisfies the activation condition by determining whether the present vehicle 1A has changed the state thereof from the parked state to the vehicle state where the present vehicle 1A starts moving backward.

First, the vehicle state determination unit 30A may determine whether the present vehicle 1A is in the parked state by using the following method. For example, when the position information of the shift lever received from the shift position sensor 18 indicates a parking (P) position, the vehicle state determination unit 30A determines that the present vehicle 1A is in the parked state. The vehicle state determination unit 30A may determine that the present vehicle 1A is in the parked state when the instruction information given by the switch received from the ignition switch 14 indicates the engine-off or the accessory power-off. The vehicle state determination unit 30A may also determine that the present vehicle 1A is in the parked state when the measurement result of the vehicle speed given by the vehicle speed sensor 16 indicates that the vehicle speed is zero for a predetermined time or longer. The vehicle state determination unit 30A may further determine that the present vehicle 1A is in the parked state when at least one of these conditions is satisfied.

After the present vehicle 1A is determined to be in the parked state, the vehicle state determination unit 30A determines whether the vehicle state has changed to the backward starting state. The determination as to whether the vehicle state is the backward starting state can be performed by determining whether the position information of the shift lever received from the shift position sensor 18 indicates a reverse (R) position.

When the vehicle state determination unit 30A determines that the vehicle state of the present vehicle 1A satisfies the activation condition, the operation unit 30B operates the detectors 12. The detectors 12 are controlled by the operation unit 30B to start to detect the other vehicle existing in the periphery of the present vehicle 1A, and start to output the detection information to the vehicle periphery warning device 10. The operation unit 30B may be configured to always operate the detectors 12 regardless of the determination result of the vehicle state determination unit 30A. The operation unit 30B may also be configured to operate the detectors 12 when power is supplied to the detectors 12 through an operation of the ignition switch 14 by a user.

The setting unit 30C sets a warning area on a downstream side in the traveling direction of the present vehicle 1A in accordance with an angle between the traveling direction of the present vehicle 1A and the traveling direction of the other vehicle.

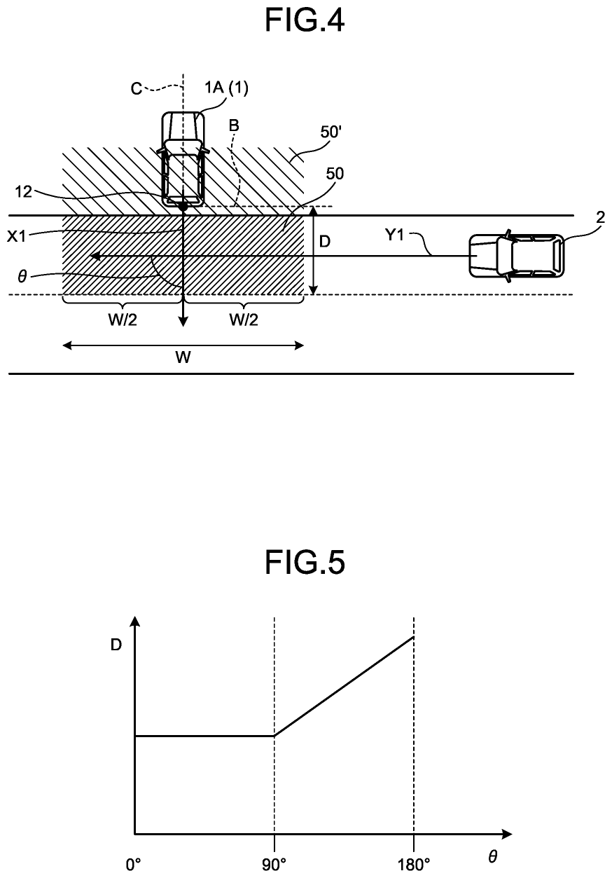

FIG. 4 is an explanatory diagram of an example of setting of a warning area 50. The warning area 50 refers to a virtual area set on a real space. The warning area 50 is an area in the real space where the warning operation is to be activated by the warning operation activator 22 when the other vehicle 2 enters the warning area 50.

More specifically, as illustrated in FIG. 4, the warning area 50 is an area specified by a predetermined width W and a distance D. The width W extends in the vehicle width direction of the present vehicle 1A with respect to a central axis C of the present vehicle 1A, which serves as the center of the width W. The distance D extends from an end B of a vehicle body of the present vehicle 1A in a traveling direction X1 toward the downstream side in the traveling direction X1.

The warning area 50 may be an area further including an area 50′ overlapping with at least part of the present vehicle 1A. In the present embodiment, a configuration will be described as an example in which the warning area 50 is the area within the distance D from the end B in the traveling direction X1 of the vehicle body of the present vehicle 1A toward the downstream side in the traveling direction X1.

In FIG. 4, the shape of the warning area 50 is a rectangle having four sides in which two sides each have the width W and the other two sides each have the distance D. Note that the shape of the warning area 50 is only required to be a quadrilateral composed of four sides in which two sides each have the width W and the other two sides each have the distance D. For example, the shape of the warning area 50 may be a parallelogram. In the present embodiment, a configuration will be described as an example in which one pair of two parallel sides of the four sides of the warning area 50 are parallel to the traveling direction X1 of the present vehicle 1A while the other pair of two parallel sides are parallel to a traveling direction Y1 of the other vehicle 2. In FIG. 4, as an example, an angle θ between the traveling direction X1 and the traveling direction Y1 is 90 degrees. Thus, the warning area 50 is indicated by a rectangular area when the angle θ is 90 degrees.

In the warning area 50, while the one pair of two parallel sides of the four sides of the warning area 50 may be parallel to the traveling direction X1 of the present vehicle 1A, the other pair of two parallel sides may be parallel to a direction orthogonal to the traveling direction X1. In this case, the warning area 50 is always an area having a rectangular shape.

The setting unit 30C determines the traveling direction Y1 of the other vehicle 2 with respect to the central axis C of the present vehicle 1A included in the detection information received from the detectors 12. The setting unit 30C also determines the traveling direction X1 of the present vehicle 1A. The setting unit 30C may determine the traveling direction X1 of the present vehicle 1A by using, for example, transitions in the steering angle specified by steering angle information given by the steering angle sensor 20, the direction of acceleration of the present vehicle 1A, and/or position information of the present vehicle 1A. The transitions in the direction of acceleration of the present vehicle 1A and in the position information of the present vehicle 1A can be determined by using an acceleration sensor and the Global Positioning System (GPS) function provided in the present vehicle 1A.

The setting unit 30C sets the warning area 50 on the downstream side in the traveling direction X1 of the present vehicle 1A in accordance with the angle θ between the traveling direction X1 of the present vehicle 1A and the traveling direction Y1 of the other vehicle 2.

In more detail, the setting unit 30C sets the distance D of the warning area 50 in accordance with the angle θ between the traveling direction X1 of the present vehicle 1A and the traveling direction Y1 of the other vehicle 2.

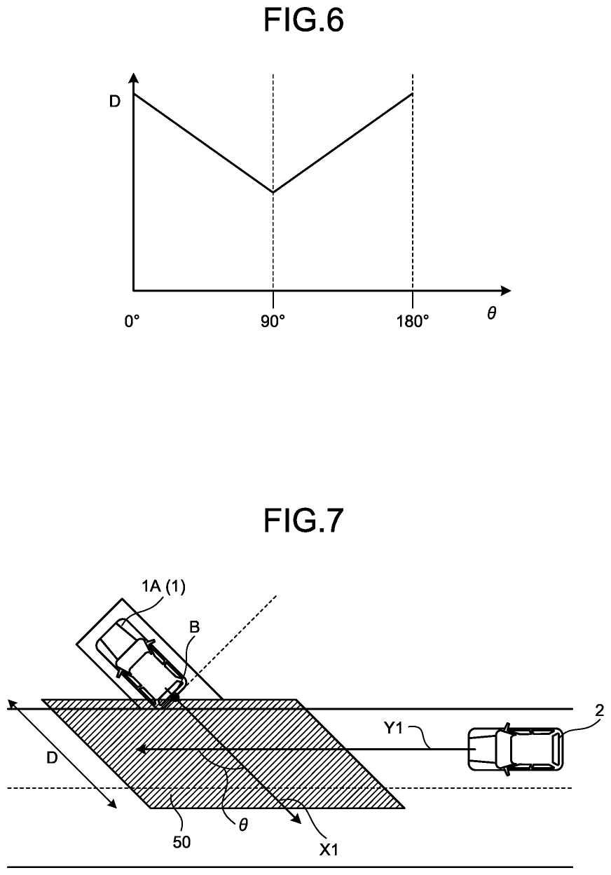

FIGS. 5 and 6 are explanatory diagrams of relations between the angle θ and the distance D. In FIGS. 5 and 6, the horizontal axis represents the angle θ between the traveling direction X1 of the present vehicle 1A and the traveling direction Y1 of the other vehicle 2, and the vertical axis represents the distance D.

As illustrated in FIG. 5, when the angle θ is within 0 degrees to 90 degrees, the setting unit 30C sets the distance D to a constant reference distance set in advance. When the angle θ exceeds 90 degrees, the setting unit 30C sets the distance D to be closer to the reference distance D as the angle θ is closer to 90 degrees, and sets the distance D to be farther from the reference distance D as the angle θ is closer to 180 degrees.

Alternatively, as illustrated in FIG. 6, the setting unit 30C may set the distance D to be smaller as the angle θ is closer to 90 degrees, and to be larger as the angle θ is further away from 90 degrees.

While FIGS. 5 and 6 illustrate the configurations in which the distance D linearly changes as the angle θ changes, the distance D may change in a curved manner or a stepwise manner.

The setting unit 30C stores in advance, in the storage 24, the relation information indicating the relation between the angle θ and the distance D illustrated in FIG. 5 or 6. Then, the setting unit 30C determines, on the basis of the relation information, the distance D corresponding to the angle θ between the traveling direction X1 of the present vehicle 1A and the traveling direction Y1 of the other vehicle 2, which have been determined by using, for example, the detection information received from the detectors 12. Then, the setting unit 30C sets the determined distance D as the distance D of the warning area 50.

The description will be continued referring back to FIG. 4. The width W of the warning area 50 may be a value set in advance. The width W of the warning area 50 may be set in accordance with the position of the other vehicle 2 with respect to the present vehicle 1A. For example, the setting unit 30C may set the width W to be larger as the relative speed of the other vehicle 2 with respect to the present vehicle 1A is higher. Specifically, when the relative speed of the other vehicle 2 with respect to the present vehicle 1A is equal to or lower than a reference speed, the setting unit 30C sets a predetermined fixed width as the width W of the warning area 50. When the relative speed of the other vehicle 2 with respect to the present vehicle 1A exceeds the reference speed, the setting unit 30C may set, as the width W of the warning area 50, the width W that is larger than the fixed width as the relative speed is higher than the reference speed. The setting unit 30C may set the width W to be smaller as the relative speed of the other vehicle 2 with respect to the present vehicle 1A is higher.

As a result of the setting of the warning area 50 by the setting unit 30C, the warning area 50 corresponding to the angle θ between the traveling direction X1 of the present vehicle 1A and the traveling direction Y1 of the other vehicle 2 is set on the downstream side in the traveling direction X1 of the vehicle 1.

The warning area 50 illustrated in FIG. 4 is set when the angle θ between the traveling direction X1 of the present vehicle 1A and the traveling direction Y1 of the other vehicle 2 is 90 degrees. In this case, the setting unit 30C sets the distance D by using the relation information illustrated in FIG. 5 or 6, and thereby the warning area 50 is set with the distance D which is the shortest settable distance.

FIG. 7 is an explanatory diagram of an exemplary case where the angle θ between the traveling direction X1 of the present vehicle 1A and the traveling direction Y1 of the other vehicle 2 exceeds 90 degrees. In this case, the setting unit 30C sets the warning area 50 by using the relation information illustrated in FIG. 5 or 6, and thereby the warning area 50 is set with the distance D which is larger than that in the case where the angle θ is 90 degrees.

Accordingly, in a scene where a warning is needed to give notification that the other vehicle 2 is approaching the present vehicle 1A, the setting unit 30C can appropriately set the warning area 50 in accordance with the angle θ.

Note that the setting unit 30C may set the warning area 50 for each another vehicle 2. Thus, in a case where two or more of the other vehicles 2 are approaching the present vehicle 1A, the warning area 50 may be set for each of the approaching vehicles 2.

The description will be continued referring back to FIG. 1. In some cases, accuracy of detecting the other vehicle 2 by the detectors 12 may deteriorate. In such cases, the setting unit 30C has difficulty in setting the correct warning area 50.

In consideration of the above, the accuracy determination unit 30D determines whether the accuracy of detecting the other vehicle 2 by the detector(s) 12 is lower than a predetermined degree of accuracy.

The accuracy determination unit 30D determines that the accuracy of detection is lower than the predetermined degree of accuracy, when, for example, at least one of the following conditions is satisfied: a condition that the other vehicle 2 whose speed is equal to or lower than a predetermined set speed is detected, and a condition that the other vehicle 2 is detected in an area within a predetermined range from an edge of a detection angle of the detector 12.

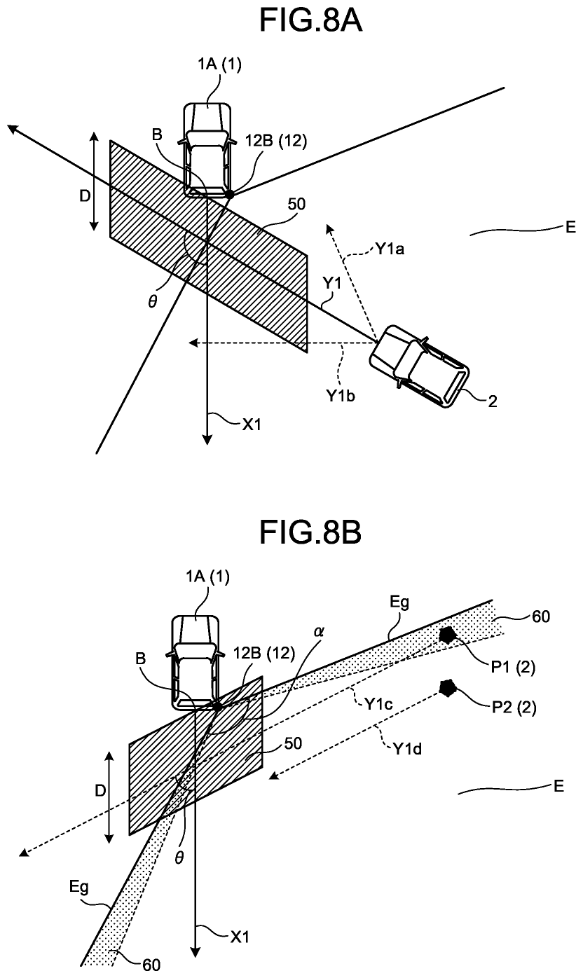

FIG. 8A is an explanatory diagram of an example of the case where the speed of the other vehicle 2 is equal to or lower than the set speed. It is assumed that the speed of the other vehicle 2 detected by the detector 12 is equal to or lower than the set speed. In this case, the traveling direction Y1 of the other vehicle 2 is likely to shift to a direction Y1a or a direction Y1b before the other vehicle 2 reaches the warning area 50 set based on the detection information about the other vehicle 2.

In consideration of the above, when the other vehicle 2 whose speed is equal to or lower than the predetermined set speed is detected, the accuracy determination unit 30D determines that the accuracy of detection is lower than the predetermined degree of accuracy. For example, the accuracy determination unit 30D determines whether the accuracy of detection is lower than the predetermined degree of accuracy by determining whether the speed of the other vehicle 2 included in the detection information received from the detector 12 is equal to or lower than the set speed. The set speed may be set in advance. For example, the set speed is set to an upper limit value of the vehicle speed at which the traveling direction Y1 can change before the other vehicle 2 used for setting the warning area 50 reaches the warning area 50.

FIG. 8B is an explanatory diagram of an example of the case where the other vehicle 2 is detected in an area 60 within the predetermined range from an edge Eg of a detection angle α of the detector 12. The detection angle α of the detector 12 refers to a detection angle centered on the detector 12 provided on the present vehicle 1A, and may be called a field of view (FOV). The edge Eg of the detection angle α refers to one of two lines passing through the detector 12 among lines defining the detection range E (EA or EB in FIG. 2) of the detector 12 defined by the detection angle α.

A case will be assumed where the detector 12 detects the other vehicle 2 overlapping with at least part of the area 60. In this case, the actual position of the other vehicle 2 may be a position deviating from the position where the other vehicle 2 is detected. For example, the position of the other vehicle 2 detected to be located in a position P1 by the detector 12 may actually be located in a position P2. In this case, if the warning area 50 is set on the basis of the detection information about the other vehicle 2 detected by the detector 12, the warning area 50 is to be set in a range in which the actual position of the other vehicle 2 is not included.

In consideration of the above, when the other vehicle 2 is detected in the area 60 within the predetermined range from the edge Eg of the detection angle α of the detector 12, the accuracy determination unit 30D determines that the accuracy of detection is lower than the predetermined degree of accuracy. For example, the accuracy determination unit 30D may determine whether the other vehicle 2 has been detected in the area 60 by determining whether the position of the other vehicle 2 included in the detection information received from the detector 12 is a position in the area 60. The accuracy determination unit 30D may store in the storage 24 in advance the positions of the detectors 12A and 12B provided on the present vehicle 1A and the detection angle α to determine the accuracy by using the stored data.

The description will be continued referring back to FIG. 1. When the accuracy of detecting the other vehicle 2 by the detector 12 is lower than the predetermined degree of accuracy, the corrector 30E corrects the warning area 50. That is, in response to determining by the accuracy determination unit 30D that the accuracy of detection is lower than the predetermined degree of accuracy, the corrector 30E corrects the warning area 50 set by the setting unit 30C.

Specifically, when the other vehicle 2 whose speed is equal to or lower than the predetermined set speed is detected, the corrector 30E corrects the warning area 50 set by the setting unit 30C to be enlarged or reduced.

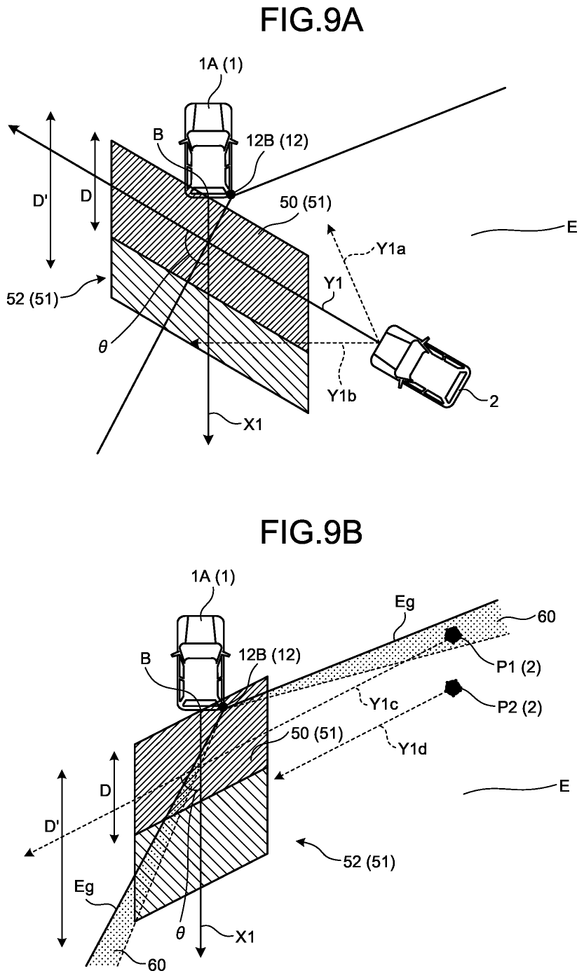

FIG. 9A is an explanatory diagram of an example of the correction of the warning area 50 when the accuracy of detecting the other vehicle 2 by the detector 12 is lower than the predetermined degree of accuracy.

For example, the corrector 30E extends the distance D of the warning area 50 set by the setting unit 30C to a distance D′. Through this processing, the corrector 30E corrects the warning area 50 to a warning area 52 serving as the corrected warning area 50. That is, the corrector 30E corrects the warning area 50 to become an area larger than the set warning area 50. As illustrated in FIG. 9A, the warning area 52 is an area obtained by correcting the distance D of the warning area 50 to the distance D′ longer than the distance D.

As mentioned above, when the speed of the other vehicle 2 is equal to or lower than the predetermined speed, the traveling direction Y1 of the other vehicle 2 may shift to, for example, the direction Y1a or the direction Y1b before the other vehicle 2 reaches the warning area 50 which has been set on the basis of the detection information about this vehicle 2. Even in such a case, the corrector 30E corrects the warning area 50 by extending the distance D, so that the warning area 52 for appropriately watching out for the other vehicle 2 can be obtained.

In FIG. 9A, as an example, the warning area 50 is corrected to obtain the warning area 52 by extending the distance D of the warning area 50 to the distance D′. Alternatively, the corrector 30E may correct the warning area 50 by shortening the distance D of the warning area 50. That is, the processor 30 may correct the warning area 50 to obtain the warning area 52 that is smaller than the warning area 50. In this case, the corrector 30E can suppress activation of unnecessary warning operations.

When the other vehicle 2 is detected in the area 60 within the predetermined range from the edge Eg of the detection angle α of the detector 12, the corrector 30E corrects the warning area 50 set by the setting unit 30C to be enlarged or reduced.

FIG. 9B is an explanatory diagram of an example of the correction of the warning area 50 when the other vehicle 2 is detected in the area 60 within the predetermined range from the edge Eg of the detection angle α of the detector 12.

It is assumed that the corrector 30E corrects the distance D of the warning area 50 set by the setting unit 30C to extend to the distance D′. Through this processing, the corrector 30E corrects the warning area 50 to obtain the warning area 52 serving as the corrected warning area 50. In this case, the corrector 30E corrects the warning area 50 to become an area larger than the set warning area 50. As illustrated in FIG. 9B, the warning area 52 is an area obtained by extending the distance D of the warning area 50 to the distance D′.

As mentioned above, when the detector 12 detects the other vehicle 2 at a position overlapping with at least part of the area 60, the actual position of the other vehicle 2 may be a position deviating from the position where the other vehicle 2 is detected. Even in such a case, the corrector 30E corrects the warning area 50 by extending the distance D, so that the warning area 52 for appropriately watching out for the other vehicle 2 can be obtained.

In FIG. 9B, as an example, the warning area 50 is corrected to obtain the warning area 52 by extending the distance D of the warning area 50 to the distance D′. Alternatively, the corrector 30E may correct the warning area 50 by shortening the distance D of the warning area 50. That is, the processor 30 may correct the warning area 50 to obtain the warning area 52 that is smaller than the warning area 50. In this case, the corrector 30E can suppress the activation of unnecessary warning operations.

Hereinafter, the warning area 50 and the warning area 52 serving as the corrected warning area 50 are each called a warning area 51 when they are collectively described.

The description will be continued referring back to FIG. 1. The entry determination unit 30F serves to determine whether the other vehicle 2 has entered the warning area 51. Specifically, the entry determination unit 30F determines whether the position of the other vehicle 2 included in the detection information received from the detector 12 is located within the warning area 50 set by the setting unit 30C or within the warning area 52 corrected by the corrector 30E.

The activation controller 30G activates the warning operation activator 22 when the other vehicle 2 has entered the warning area 51. In the present embodiment, in response to determining by the entry determination unit 30F that the other vehicle 2 has entered the warning area 51, the activation controller 30G activates the warning operation activator 22.

The warning operation activator 22 performs the warning operation by outputting, for example, a sound, light, an image, and/or vibration, under the control of the activation controller 30G. Therefore, when the other vehicle 2 has entered the warning area 51, the warning operation activator 22 can give, to the occupant of the present vehicle 1A, notification that caution is required.

The following describes an example of the information processing performed by the vehicle periphery warning device 10 of the present embodiment.

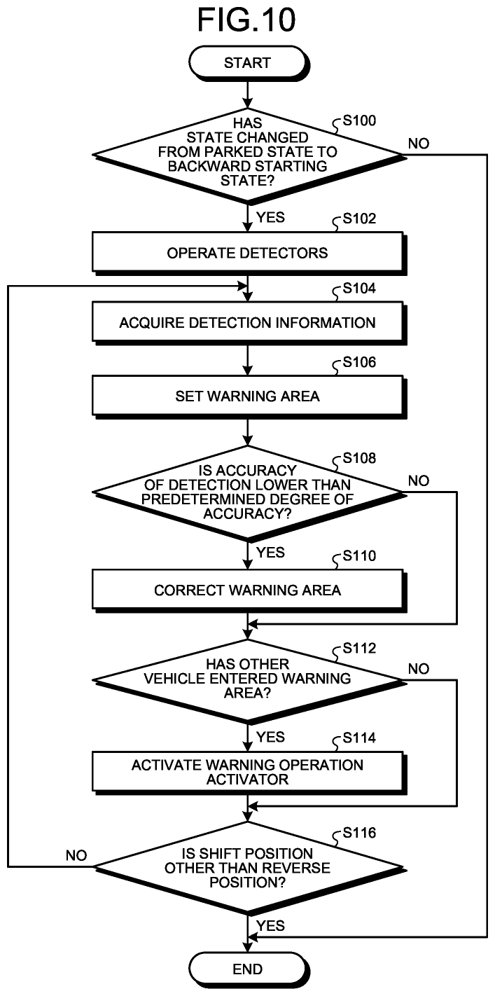

FIG. 10 is a flowchart illustrating the example of the information processing performed by the vehicle periphery warning device 10.

The vehicle state determination unit 30A determines whether the present vehicle 1A has changed from the parked state to the state where the present vehicle 1A starts moving backward (Step S100). When a negative determination is made at Step S100 (No at Step S100), this routine ends. When an affirmative determination is made at Step S100 (Yes at Step S100), processing at Step S102 is performed.

At Step S102, the operation unit 30B operates the detectors 12 (Step S102). The processing at Step S102 causes the detectors 12 to start to detect the other vehicle in the periphery of the present vehicle 1A, and start to output the detection information to the vehicle periphery warning device 10.

Subsequently, the setting unit 30C acquires the detection information from the detectors 12 (Step S104). The setting unit 30C then sets the warning area 50 on the basis of the detection information received at Step S104 (Step S106). The setting unit 30C sets the warning area 50 on the downstream side in the traveling direction of the present vehicle 1A in accordance with the angle θ between the traveling direction X1 of the present vehicle 1A and the traveling direction Y1 of the other vehicle 2.

The accuracy determination unit 30D determines whether the accuracy of detection by the detector 12 is lower than the predetermined degree of accuracy (Step S108). The accuracy determination unit 30D determines whether the accuracy of detection by the detector 12 when the detection information used for setting the warning area 50 at Step S106 was detected is lower than the predetermined degree of accuracy. When the detection accuracy is lower than the predetermined degree of accuracy (Yes at Step S108), processing at Step S110 is performed.

At Step S110, the corrector 30E corrects the warning area 50 set at Step S106 to be enlarged or reduced (Step S110). By the processing at Step S110, the warning area 50 is corrected to obtain the warning area 52. Then, processing at Step S112 is performed.

On the other hand, when the accuracy of detection is equal to or higher than the predetermined degree of accuracy (No at Step S108), the processing at Step S112 is performed. In this case, the warning area 50 set at Step S106 is used without correction.

The entry determination unit 30F determines whether the other vehicle 2 has entered the warning area 51 being the warning area 50 or the warning area 52 (Step S112). If a negative determination is made at Step S112 (No at Step S112), processing at Step S116 to be described later is performed. If an affirmative determination is made at Step S112 (Yes at Step S112), processing at Step S114 is performed.

At Step S114, the activation controller 30G activates the warning operation activator 22 (Step S114). In the processing at Step S114, under the control of the activation controller 30G, the warning operation activator 22 performs the warning operation by outputting, for example, a sound, light, an image, and/or vibration. As a result, when the other vehicle 2 has entered the warning area 51, the warning operation activator 22 can give, to the occupant of the present vehicle 1A, notification that caution is required. Then, the processing at Step S116 is performed.

At Step S116, the vehicle state determination unit 30A determines whether the shift position is other than the reverse position (Step S116). The vehicle state determination unit 30A performs the determination at Step S116 by determining whether the information indicating the position of the shift lever received from the shift position sensor 18 indicates a position other than the reverse (R) position. If a negative determination is made at Step S116 (No at Step S116), the processing at Step S104 described above is performed again. If an affirmative determination is made at Step S116 (Yes at Step S116), this routine ends.

In the present embodiment, the configuration has been described as an example in which the vehicle state determination unit 30A determines whether the vehicle state satisfies the activation condition of the warning operation activator 22 by determining whether the vehicle state of the present vehicle 1A has changed from the parked state to the backward starting state.

The activation condition of the warning operation activator 22 is not limited to the transition from the parked state to the backward starting state. The activation condition of the warning operation activator 22 may be, for example, a transition from the parked state to a forward starting state, or input of an activation instruction signal to the warning operation activator 22 through, for example, an operational instruction by the user. In this case, the operation unit 30B may operate the detectors 12 when any of the above-mentioned activation conditions is satisfied, and the setting unit 30C, the accuracy determination unit 30D, the corrector 30E, the entry determination unit 30F, and the activation controller 30G may perform the above-described processing.

Specifically, at the time of the determination processing at Step S100 in the flowchart illustrated in FIG. 10, the vehicle state determination unit 30A may determine whether any one of the above-mentioned activation conditions is satisfied. At the time of the determination processing at Step S116, the vehicle state determination unit 30A may determine whether the vehicle state has become a state not satisfying the activation condition used for the determination processing at Step S100.

That is, in this case, not only when the present vehicle 1A has changed the vehicle state thereof from the parked state to the backward starting state, but when the present vehicle 1A is brought into the state satisfying the activation condition, the setting of the warning area 50, the correction of the warning area 50, the determination of the entry of the other vehicle into the warning area 50, and the activation of the warning operation activator 22 can be performed.

As described above, the vehicle periphery warning device 10 of the present embodiment includes the detectors 12, the setting unit 30C, the activation controller 30G, and the corrector 30E. The detectors 12 detect the other vehicle 2. The setting unit 30C sets the warning area 50 on the downstream side in the traveling direction of the present vehicle 1A in accordance with the angle θ between the traveling direction X1 of the present vehicle 1A and the traveling direction Y1 of the other vehicle 2. When the other vehicle 2 has entered the warning area 51, which is the warning area 50 or the warning area 52, the activation controller 30G activates the warning operation activator 22 serving to perform the warning operation. When the accuracy of detecting the other vehicle 2 by the detector 12 is lower than the predetermined degree of accuracy, the corrector 30E corrects the set warning area 50 to obtain the warning area 52.

As described above, in the vehicle periphery warning device 10 of the present embodiment, the set warning area 50 is corrected when the accuracy of detecting the other vehicle 2 by the detector 12 is lower than the predetermined degree of accuracy. As a result, the vehicle periphery warning device 10 of the present embodiment can set the accurate warning area 51 even when the accuracy of detecting the other vehicle 2 by the detector 12 deteriorates.

Therefore, the vehicle periphery warning device 10 of the present embodiment can appropriately watch out for the other vehicle 2.

In the present embodiment, the configuration in which the vehicle periphery warning device 10 is mounted on the vehicle 1 has been described as an example. Alternatively, the vehicle periphery warning device 10 may be provided outside the vehicle 1. The vehicle periphery warning device 10 is simply required to be communicably connected to various electronic devices, such as the detectors 12, the ignition switch 14, the vehicle speed sensor 16, the shift position sensor 18, the steering angle sensor 20, the warning operation activator 22, and the storage 24, each provided on the vehicle 1. Therefore, the vehicle periphery warning device 10 may be installed in an information processing device provided outside the vehicle 1. In this case, the information processing device with the vehicle periphery warning device 10 may be configured to be communicable with the above-listed various electronic devices via, for example, a network.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A vehicle periphery warning device comprising:
a detector device configured to detect a second vehicle differing from a first vehicle; and
a hardware processor connected to a memory and configured to function as
a setting unit serving to set a warning area on a downstream side in a traveling direction of the first vehicle in accordance with an angle between the traveling direction of the first vehicle and a traveling direction of the second vehicle,
an activation controller serving to, when the second vehicle enters the warning area, activate a warning operation activator device performing a warning operation, and
a corrector serving to correct the warning area when accuracy of detecting the second vehicle by the detector device is lower than a predetermined degree of accuracy.

2. The vehicle periphery warning device according to claim 1, wherein
the hardware processor is configured to further function as an accuracy determination unit serving to determine whether the accuracy of detecting the second vehicle by the detector device is lower than the predetermined degree of accuracy, and
the accuracy determination unit serves to determine that the accuracy of the detection is lower than the predetermined degree of accuracy when at least one of conditions is satisfied, the conditions including
a condition that the second vehicle whose speed is equal to or lower than a predetermined set speed is detected, and
a condition that the second vehicle is detected in an area within a predetermined range from an edge of a detection angle of the detector device.

3. The vehicle periphery warning device according to claim 2, wherein the corrector serves to correct the warning area to be enlarged or reduced when the second vehicle whose speed is equal to or lower than the predetermined set speed is detected.

4. The vehicle periphery warning device according to claim 2, wherein the corrector serves to correct the warning area to be enlarged or reduced when the second vehicle is detected in the area within the predetermined range from the edge of the detection angle of the detector device.

5. The vehicle periphery warning device according to claim 3, wherein the corrector serves to correct the warning area to be enlarged or reduced when the second vehicle is detected in the area within the predetermined range from the edge of the detection angle of the detector device.

6. A vehicle periphery warning method comprising:
detecting a second vehicle differing from a first vehicle;
setting a warning area on a downstream side in a traveling direction of the first vehicle in accordance with an angle between the traveling direction of the first vehicle and a traveling direction of the second vehicle;
activating, when the second vehicle enters the warning area, a warning operation activator device performing a warning operation; and
correcting the warning area when accuracy of detecting the second vehicle is lower than a predetermined degree of accuracy.

7. The vehicle periphery warning method according to claim 6, further comprising determining whether the accuracy of detecting the second vehicle is lower than the predetermined degree of accuracy,
wherein the determining is performed by determining that the accuracy of the detection is lower than the predetermined degree of accuracy when at least one of conditions is satisfied, the conditions including
a condition that the second vehicle whose speed is equal to or lower than a predetermined set speed is detected, and
a condition that the second vehicle is detected in an area within a predetermined range from an edge of a detection angle of the detection of the second vehicle.

8. The vehicle periphery warning method according to claim 7, wherein the correcting is performed by correcting the warning area to be enlarged or reduced when the second vehicle whose speed is equal to or lower than the predetermined set speed is detected.

9. The vehicle periphery warning method according to claim 7, wherein the correcting is performed by correcting the warning area to be enlarged or reduced when the second vehicle is detected in the area within the predetermined range from the edge of the detection angle of the detection of the second vehicle.

10. The vehicle periphery warning method according to claim 8, wherein the correcting is performed by correcting the warning area to be enlarged or reduced when the second vehicle is detected in the area within the predetermined range from the edge of the detection angle of the detection of the second vehicle.
